(19) United States
(12) Patent Application Publication
(10) Pub. No.: US 2018/0052865 A1
(43) Pub. Date: Feb. 22, 2018

(54) FACILITATING THE SHARING OF RELEVANT CONTENT

(71) Applicant: International Business Machines Corporation, Armonk, NY (US)

(72) Inventors: Alaa Abou Mahmoud, Dracut, MA (US); Paul R. Bastide, Boxford, MA (US); Fang Lu, Billerica, MA (US)

(21) Appl. No.: 15/799,101

(22) Filed: Oct. 31, 2017

Related U.S. Application Data
(63) Continuation of application No. 15/237,787, filed on Aug. 16, 2016.

(51) Int. Cl. G06F 17/30; G06F 21/62; H04L 29/06; H04L 29/08

(52) U.S. Cl. CPC G06F 17/30165; G06F 21/6218; H04L 63/101; H04L 67/22; G06F 17/30867; H04L 67/10

(57) ABSTRACT

A method, system and computer program product for sharing content of interest. Copy actions of content (e.g., photos, text) by users from various sources (e.g., documents, files) are monitored and detected. Users having copied content that are within a threshold degree of similarity are identified. A group consisting of these identified users is then formed. Copy actions of content from the users of the formed group are then monitored. If content copied by a user of the formed group is within a threshold degree of similarity to the content previously copied by one or more other users of the formed group, then a recommendation is made to the user who performed the copy action to share the copied content to the formed group. In this manner, content of interest (relevant content) is shared to those users without requiring those users to actively discover such content of interest.

### TECHNICAL FIELD

The present invention relates generally to content sharing, and more particularly to facilitating the sharing of relevant content.

### BACKGROUND

There are various services (e.g., DropBox®, Google® Drive) that allow users to share files, documents and folders amongst each other. The content shared in such services may be used and reused as well as repurposed by the receiving user. For example, the receiving user may copy a slide in the shared content to be used in a business presentation being prepared by the user. In such a manner, the receiving user saves time in creating the presentation by not having to create the slide.

Unfortunately, users are limited to reusing content that were directly shared to them. There may be content by the user's friends, colleagues, business associates, etc. that would be useful to be utilized by the user; however, the user does not have the knowledge that such content exists. As a result, the user is forced to “discover” available content that would be useful to the user in creating documents, presentations, etc. By requiring the user to “discover” content of interest, the user is forced to engage in a time consuming and inefficient activity.

### SUMMARY

In one embodiment of the present invention, a method for sharing content of interest comprises monitoring and detecting copy actions of content by users. The method further comprises identifying a plurality of users who copied content within a threshold degree of similarity based on the detected copy actions of content by the users. The method additionally comprises forming a group comprising the plurality of users. Furthermore, the method comprises monitoring copy actions of content from the plurality of users of the group. Additionally, the method comprises detecting a copy of a first content from a first user of the group. In addition, the method comprises recommending, by a processor, to the first user to share the first content to the group in response to the first content being within a threshold degree of similarity of content previously copied by one or more other users of the group.

Other forms of the embodiment of the method described above are in a system and in a computer program product.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE DRAWINGS

A better understanding of the present invention can be obtained when the following detailed description is considered in conjunction with the following drawings, in which:

FIG. 1 illustrates an embodiment of the present invention of a communication system configured in accordance with an embodiment of the present invention;

FIG. 2 illustrates an embodiment of the present invention of a hardware configuration of a content sharing system configured in accordance with an embodiment of the present invention;

FIG. 3 is a flowchart of a method for forming groups of users based on detecting the copying of similar content by the users of the group in accordance with an embodiment of the present invention; and

FIG. 4 is a flowchart of a method for sharing content of interest to other users in accordance with an embodiment of the present invention.

### DETAILED DESCRIPTION

The present invention comprises a method, system and computer program product for sharing content of interest. In one embodiment of the present invention, copy actions of content (e.g., photos, stories, designs, drawings, recording, videos, text) by users from various sources (e.g., documents, files, spreadsheets, presentations, web pages, wikis, forums, browsers) are monitored and detected. Users having copied content that are within a threshold degree of similarity are identified based on the information (e.g., content, content source, time of detected copy action) obtained from the detected copy actions. A group consisting of these identified users is then formed. Copy actions of content from the users of the formed group are then monitored. Upon detecting the copying of content from a user of the formed group, a determination is made as whether the copied content is similar to the content previously copied by one or more other users of the formed group within a threshold degree of similarity. If the content copied by a user of the formed group is within a threshold degree of similarity to the content previously copied by one or more other users of the formed group, then a recommendation is made to the user who performed the copy action to share the copied content to the formed group. Since the content copied is within a threshold degree of similarity to the content previously copied by one or more other users of the formed group, it may be likely that such content would be of interest to other users of the group. As a result, by providing content to users of the formed group that is similar to content previously copied by one or more users of the formed group, such content may be likely to be of interest to those users. In this manner, content of interest (relevant content) is shared to those users without requiring those users to actively discover such content of interest.

In the following description, numerous specific details are set forth to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

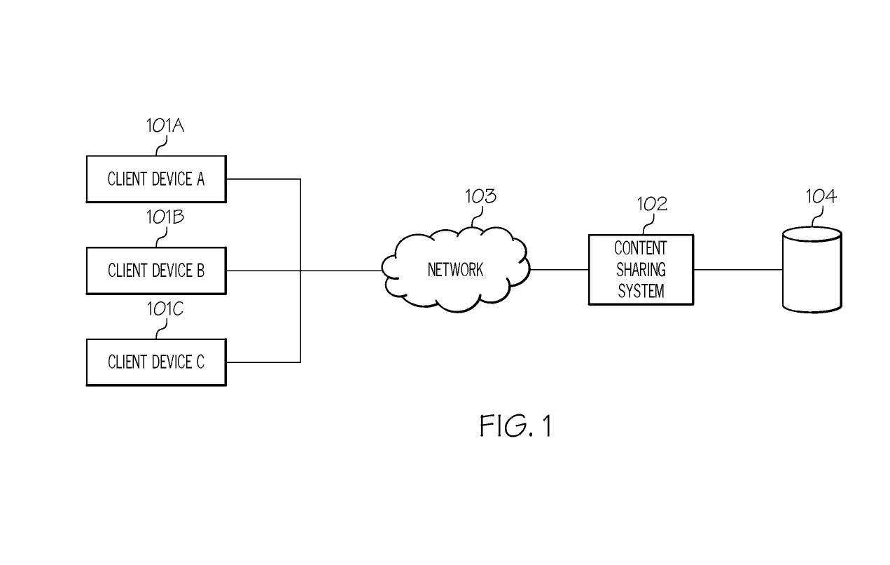

Referring now to the Figures in detail, FIG. 1 illustrates an embodiment of the present invention of a communication system 100 configured in accordance with an embodiment of the present invention. Referring to FIG. 1, communication system 100 includes a community of users (e.g., members of a file sharing repository) using client devices 101A-101C (identified as “Client Device A,” “Client Device B,” and “Client Device C,” respectively, in FIG. 1) connected to a content sharing system 102 via a network 103. Client devices 101A-101C may collectively or individually be referred to as client devices 101 or client device 101, respectively. Client device 101 may be a portable computing unit, a Personal Digital Assistant (PDA), a smartphone, a laptop computer, a mobile phone, a navigation device, a game console, a desktop computer system, a workstation, an Internet appliance and the like. It is noted that both client devices 101 and the users of client devices 101 may be identified with element number 101.

Referring to FIG. 1, network 103 may be, for example, a local area network, a wide area network, a wireless wide area network, a circuit-switched telephone network, a Global System for Mobile Communications (GSM) network, Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present invention.

Communication system 100 further includes a file sharing repository 104 connected to content sharing system 102. In one embodiment, any user of client device 101 may be the creator of content (e.g., photos, stories, designs, drawings, recording, videos, text, etc.) which is stored in file sharing depository 104 by content sharing system 102. Such content may be created from various types of sources, such as documents (e.g., word processing documents), files, spreadsheets, presentations, web pages, wikis, forums and browsers. In one embodiment, content sharing system 102 is configured to share the created content stored in file sharing repository 104 at the request of user 101 to any other user 101. While FIG. 1 illustrates a single repository for storing content to be shared, it is noted that the principles of the present invention are not to be limited in such a manner. Instead, the content to be stored and shared may be stored in various repositories, including in separate locations.

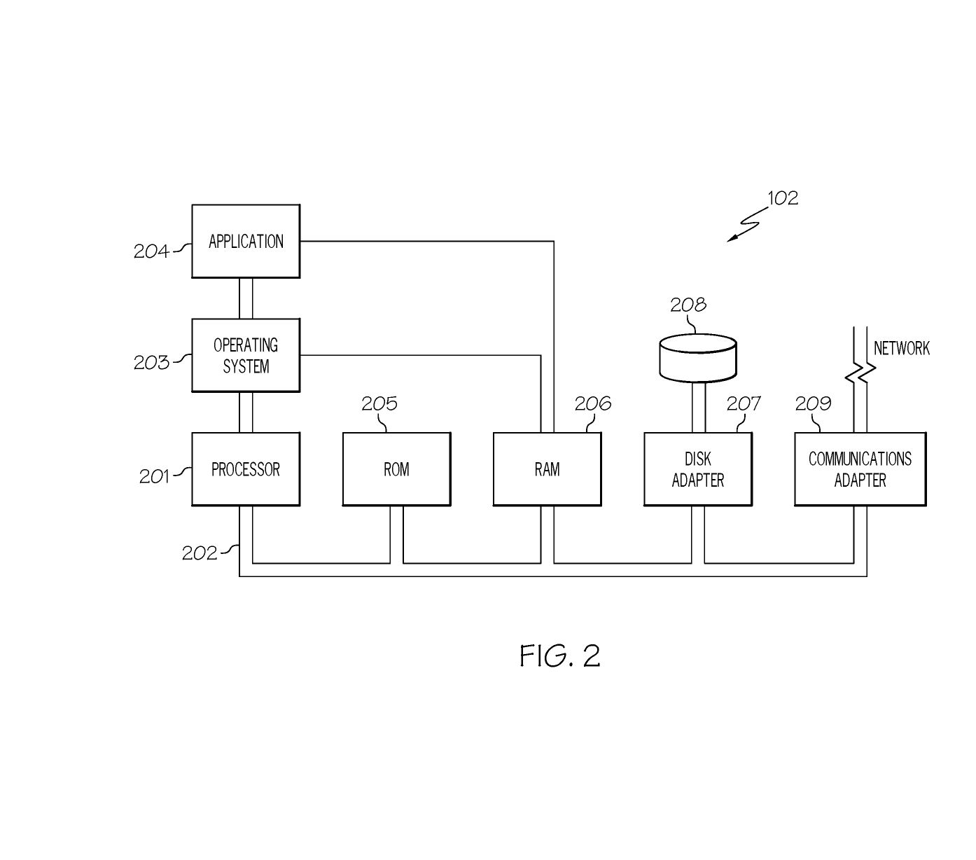

As discussed further herein, content sharing system 102 is further configured to facilitate the sharing of relevant content to users 101 without requiring user 101 to actively discover content of interest. A description of the hardware configuration of content sharing system 102 is provided below in connection with FIG. 2.

System 100 is not to be limited in scope to any one particular network architecture. System 100 may include any number of client devices 101, content sharing systems 102, networks 103 and repositories 104.

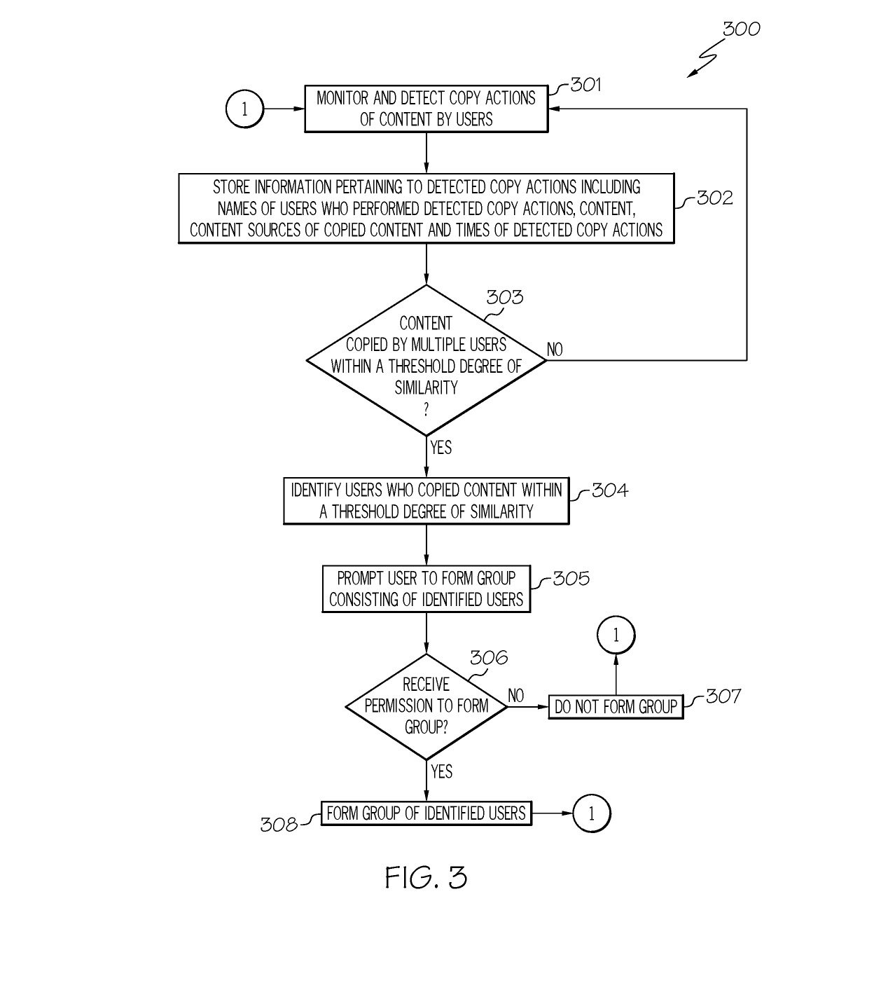

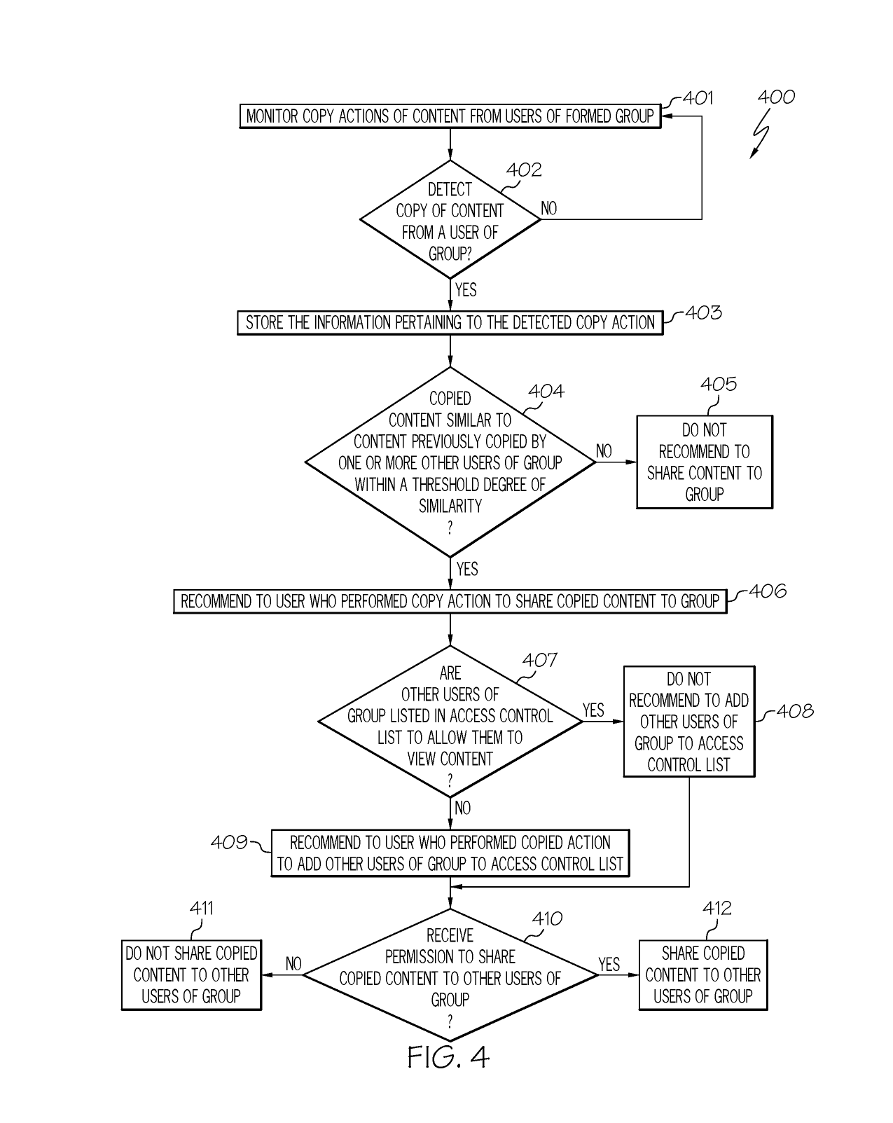

Referring now to FIG. 2, FIG. 2 illustrates an embodiment of the present invention of a hardware configuration of content sharing system 102 (FIG. 1), which is representative of a hardware environment for practicing the present invention. Referring to FIG. 2, content sharing system 102 has a processor 201 coupled to various other components by system bus 202. An operating system 203 runs on processor 201 and provides control and coordinates the functions of the various components of FIG. 2. An application 204 in accordance with the principles of the present invention runs in conjunction with operating system 203 and provides calls to operating system 203 where the calls implement the various functions or services to be performed by application 204. Application 204 may include, for example, a program for sharing content of interest as discussed further below in association with FIGS. 3-4.

Referring again to FIG. 2, read-only memory (“ROM”) 205 is coupled to system bus 202 and includes a basic input/output system (“BIOS”) that controls certain basic functions of content sharing system 102. Random access memory (“RAM”) 206 and disk adapter 207 are also coupled to system bus 202. It should be noted that software components including operating system 203 and application 204 may be loaded into RAM 206, which may be content sharing system's 102 main memory for execution. Disk adapter 207 may be an integrated drive electronics (“IDE”) adapter that communicates with a disk unit 208, e.g., disk drive. It is noted that the program for sharing content of interest, as discussed further below in association with FIGS. 3-4, may reside in disk unit 208 or in application 204.

Content sharing system 102 may further include a communications adapter 209 coupled to bus 202. Communications adapter 209 interconnects bus 202 with an outside network (e.g., network 103 of FIG. 1) thereby allowing content sharing system 102 to communicate with client devices 101.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As stated in the Background section, there are various services (e.g., DropBox®, Google® Drive) that allow users to share files, documents and folders amongst each other. The content shared in such services may be used and reused as well as repurposed by the receiving user. For example, the receiving user may copy a slide in the shared content to be used in a business presentation being prepared by the user. In such a manner, the receiving user saves time in creating the presentation by not having to create the slide. Unfortunately, users are limited to reusing content that were directly shared to them. There may be content by the user's friends, colleagues, business associates, etc. that would be useful to be utilized by the user; however, the user does not have the knowledge that such content exists. As a result, the user is forced to “discover” available content that would be useful to the user in creating documents, presentations, etc. By requiring the user to “discover” content of interest, the user is forced to engage in a time consuming and inefficient activity.

The principles of the present invention provide a means for sharing content of interest (relevant content) to users without requiring the users to actively discover such content of interest as discussed below in connection with FIGS. 3-4. FIG. 3 is a flowchart of a method for forming groups of users based on detecting the copying of similar content by the users of the group. FIG. 4 is a flowchart of a method for sharing content of interest to other users.

As stated above, FIG. 3 is a flowchart of a method 300 for forming groups of users 101 (FIG. 1) based on detecting the copying of similar content by the users 101 of the group in accordance with an embodiment of the present invention.

Referring to FIG. 3, in conjunction with FIGS. 1-2, in step 301, content sharing system 102 monitors and detects copy actions of content by users 101. Copy actions may include the copying of any type of content, such as photos, stories, designs, drawings, recordings, videos, text, etc., from any type of source, such as documents (e.g., word processing documents), files, spreadsheets, presentations, web pages, wikis, forums and browsers.

In step 302, content sharing system 102 stores the information pertaining to the detected copy actions including, but not limited to, the names of the users 101 who performed the detected copy actions, the content (content copied), the content sources of the copied content and the times of the detected copy actions.

In step 303, a determination is made by content sharing system 102 as to whether the content copied by multiple users 101 is within a threshold degree of similarity. In one embodiment, such a determination is made based on the detected copy actions. That is, such a determination is made based on the stored information pertaining to the detected copy actions. In one embodiment, natural language processing may be utilized by content sharing system 102 to determine the degree of similarity in the content copied by users 101 using the stored information pertaining to the detected copy actions.

For example, content sharing system 102 may utilize natural language processing to determine the meaning or topic of the copied content as well as the content sources. For example, content sharing system 102 may determine the topic of the copied content and the content sources based on the meaning of the words in the copied content as well as in the heading of the content sources. For example, content sharing system 102 may determine the meaning or topic of the copied content based on identifying keywords (e.g., sports, travel, weather) in the copied content. For instance, if content copied by multiple users 101 both include the aspect of sports, then they are more likely to be similar than content with divergent topics (e.g., quantum mechanics and Russian politics).

Content sharing system 102 may also determine the topic of the content sources, such as based on the meaning of the words in the heading of the content sources. Based on determining the topic of the content sources, content sharing system 102 may determine, at least in part, the degree of similarity of the copied content from these content sources. For instance, content copied from a PhD thesis involving quantum mechanics is not likely to be similar with content copied from a sports magazine even if similar language is used in the content copied from these sources since the content sources are very divergent in topic.

Furthermore, content sharing system 102 may utilize the timing of the detected copy actions to determine how close in similarity is the copied content. For example, a copy action that occurred over a year ago may be less likely to involve similar content to a copy action that occurred yesterday even if the content copied from these two actions utilize similar language.

In one embodiment of the present invention, the determination made by content sharing system 102 as to whether the content copied by multiple users 101 is within a threshold degree of similarity is performed using an affinity analysis or k-means clustering. Affinity analysis is a data analysis and data mining technique that discovers co-occurrence relationships among content copied by users 101. K-means clustering is a method of vector quantization for cluster analysis in data mining, where the k-means clustering aims to partition n observations (observations of content copied) into k clusters in which each observation belongs to the cluster with the nearest means, serving as a prototype of the cluster.

In one embodiment, the threshold degree of similarity is user-selected.

If the content copied by multiple users 101 is not within a threshold degree of similarity, then content sharing system 102 continues to monitor and detect copy actions of content by users 101 in step 301.

If, however, the content copied by multiple users 101 is within a threshold degree of similarity, then, in step 304, content sharing system 102 identifies those users 101 who copied content within the threshold degree of similarity based on the detected copy actions of content by users 101. For example, if content sharing system 102 detects user 101A copying content pertaining to Miguel Cabrera, a baseball player on the Detroit Tigers baseball team, from a sports magazine and detects user 101B copying content pertaining to the Detroit Tigers baseball team from a Detroit Tigers forum, then content sharing system 102 may determine that the content copied by users 101A and 101B are within a threshold degree of similarity based on the similarity of topic of copied content as well as the similarity of topic of the content sources.

In step 305, content sharing system 102 prompts user 101 (e.g., one of the users 101 who copied similar content to another user 101) to form a group consisting of the users 101 identified in step 304.

In step 306, a determination is made by content sharing system 102 as to whether it received permission from user 101 to form the group.

If content sharing system 102 does not receive permission from user 101 to form the group, then, in step 307, content sharing system 102 does not form a group. Content sharing system 102 then continues to monitor and detect copy actions of content by users 101 in step 301.

If, however, content sharing system 102 receives permission from user 101 to form the group, then, in step 308, content sharing system 102 forms the group consisting of the users 101 identified in step 304. Content sharing system 102 then continues to monitor and detect copy actions of content by users 101 in step 301.

In one embodiment, the group consisting of the users 101 identified in step 304 is automatically formed without prompting user 101 to form the group.

After forming a group of users 101 who copied content within a threshold degree of similarity, content sharing system 102 may share content copied by a user 101 or member of the group to other users 101 or members of the group as discussed below in connection with FIG. 4.

FIG. 4 is a flowchart of a method 400 for sharing content of interest to other users 101 (FIG. 1) in accordance with an embodiment of the present invention.

Referring to FIG. 4, in conjunction with FIGS. 1-3, in step 401, content sharing system 102 monitors the copy actions of content from users 101 of a formed group.

In step 402, a determination is made by content sharing system 102 as to whether it detected the copying of content from a user 101 of the formed group.

If content sharing system 102 has not detected the copying of content from a user 101 of the formed group, then content sharing system 102 continues to monitor the copy actions of content from users 101 of the formed group in step 401.

If, however, content sharing system 102 has detected the copying of content from a user 101 of the formed group, then, in step 403, content sharing system 102 stores the information pertaining to the detected copy action including, but not limited to, the name of the user 101 who performed the detected copy action, the content (content copied), the content source of the copied content and the time of the detected copy action.

In step 404, a determination is made by content sharing system 102 as to whether the copied content is similar to the content previously copied by one or more other users of the formed group within a threshold degree of similarity. As discussed above, in one embodiment, content sharing system 102 may determine if the content copied by user 101 is similar within a threshold degree to the content previously copied by other users of the formed group based on the stored information (e.g., content source, time of detected copy action, content itself) pertaining to the detected copy action.

If the content copied by a user 101 of the formed group is not within a threshold degree of similarity to the content previously copied by another user of the formed group, then, in step 405, content sharing system 102 does not recommend to share the content to other users of the group.

If, however, the content copied by a user 101 of the formed group is within a threshold degree of similarity to the content previously copied by one or more other users 101 of the formed group, then, in step 406, content sharing system 102 recommends to user 101 who performed the copy action to share the copied content to the formed group. Since the content copied is within a threshold degree of similarity to the content previously copied by one or more other users 101 of the formed group, it may be likely that such content would be of interest to other users 101 of the group. As a result, by providing content to users 101 of the formed group that is similar to content previously copied by one or more users 101 of the formed group, such content may be likely to be of interest to those users 101. In this manner, content of interest (relevant content) is shared to those users 101 without requiring those users 101 to actively discover such content of interest. Sharing content of interest in such a manner is a non-conventional way. By using computing technology to determine content of interest for users, users will not have to actively discover such content of interest.

If there is an access control list associated with the copied content recommended to be shared to the other users 101 of the group, then, in step 407, a determination is made by content sharing system 102 as to whether the other users 101 of the formed group (the other users 101 besides the user 101 who performed the copy action) are listed in the access control list to allow them to view the content to be shared. In one embodiment, an access control list may be utilized by user 101 who performed the copy action to limit the access of users 101 viewing content and/or a content source. If there is an access control list associated with the copied content recommended to be shared to the other users 101 of the group, then content sharing system 102 determines whether the other users 101 or members of the group have permission to view such copied content using the access control list.

If the other users 101 of the formed group are listed in the access control list to allow them to view the content to be shared, then, in step 408, content sharing system 102 does not recommend to user 101 who performed the copy action to add other users 101 of the group to the access control list.

If, however, one or more other users 101 of the formed group are not listed in the access control list to allow them to view the content to be shared, then, in step 409, content sharing system 102 recommends to user 101 who performed the copy action to add those users 101 to the access control list so that they will be able to view the copied content recommended to be shared.

In step 410, a determination is made by content sharing system 102 as to whether it received permission from user 101 who performed the copy action to share the copied content to the other users 101 of the group. If content sharing system 102 does not receive permission from user 101 who performed the copy action to share the copied content to other users 101 of the group, then, in step 411, content sharing system 102 does not share the copied content to the other users 101 of the group.

If, however, content sharing system 102 receives permission from user 101 who performed the copy action to share the copied content to the other users 101 of the group, then, in step 412, content sharing system 102 shares the copied content to the other users 101 of the group.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for sharing content of interest, the method comprising:
monitoring and detecting copy actions of content by users;
identifying a plurality of users who copied content within a threshold degree of similarity based on said detected copy actions of content by said users;
forming a group comprising said plurality of users;
monitoring copy actions of content from said plurality of users of said group;
detecting a copy of a first content from a first user of said group; and
recommending, by a processor, to said first user to share said first content to said group in response to said first content being within a threshold degree of similarity of content previously copied by one or more other users of said group.

2. The method as recited in claim 1 further comprising:
storing information pertaining to said detected copy actions comprising names of users who performed said detected copy actions, said content, content sources of said content copied and times of said detected copy actions.

3. The method as recited in claim 1 further comprising:
prompting said first user to form said group in response to said content copied by said plurality of users being within said threshold degree of similarity.

4. The method as recited in claim 1 further comprising:
prompting said first user to add one or more other users of said group to an access control list in response to said one or more other users of said group not being listed in said access control list.

5. The method as recited in claim 1, wherein said content copied by said plurality of users and said first content are copied from the group consisting of: a document, a file, a spreadsheet, a presentation, a web page, a wiki, a forum and a browser.

6. The method as recited in claim 1 further comprising:
determining if said content copied by said plurality of users are within said threshold degree of similarity using an affinity analysis or k-means clustering.

7. The method as recited in claim 1, wherein said users are members of a file sharing repository.
